(19) United States
(12) Patent Application Publication
(10) Pub. No.: US 2005/0112304 A1
(43) Pub. Date: May 26, 2005

(54) Item with hollowed interior or open end and method for making the same

(76) Inventor: Henry Hsu, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/976,810

(22) Filed: Nov. 1, 2004

(30) Foreign Application Priority Data
Nov. 26, 2003 (CN) 2003 2 0122166.8

(51) Int. Cl. B29C 70/34; B29C 70/44; B65D 1/00

(52) U.S. Cl. 428/34.1; 264/258; 264/314; 264/316

(57) ABSTRACT

A hollow item made of composite material and includes a hollow interior. An method for making the hollow item includes a step of preparing prepreg sheets; a step of preparing a resilient mediate layer with pre-set shape and the resilient mediate layer mounted to the prepreg sheets; a step of preparing a bladder which is enclosed by the resilient mediate layer; a step of putting the assembly of the prepreg sheets, the resilient mediate layer and the bladder in the previous step into a concavity of a mold and heating the mold to solidify the prepreg sheets, and a step of removing the solidified prepreg sheets from the concavity of the mold.

### FIELD OF THE INVENTION

The present invention relates to a hollow item with even thickness and a method for making the same.

### BACKGROUND OF THE INVENTION

A conventional tubular item such as a baseball bat “A” as shown in FIG. 5 or a shank of a golf club, is made by composite material such as carbon or glass fibers which is light and durable. The material is made to be prepreg sheets 3 which are arranged into a mold 5 as shown in FIG. 2 and a bladder 4 is enclosed by the prepreg sheets 3. The bladder 4 is inflated to push the prepreg sheets 3 contact against the inside of the concavity in the mold 5. The prepreg sheets 3 are then solidified by being heated so as to form the bat “A”. The bat “A” includes a main part 1 and a handle part 2 which has smaller diameter than that of the main part 1. However, it is noted that because of the different diameters, the bladder 4 in the prepreg sheets 3 is folded or includes wrinkles before it is inflated, such that when air is sent into he bladder 4, the bladder 4 is inflated at different ways or patterns, the folded area forms a inward protrusion 30 in the hollow interior of the bat “A” as shown in FIG. 5A and some area the bladder 4 is over inflated such that the bat “A” includes an area 32 with thinner thickness. The uneven thickness of the bat “A” results in stress concentration and the bat “A” could be broken at the thinner area 32.

The present invention intends to provide a hollow or semi-open item that includes even thickness and a method for making such items.

### SUMMARY OF THE INVENTION

The present invention relates to a hollow item that includes an even thickness. A method for making a hollow item, and the method comprises the following steps:
step 1: preparing prepreg sheets;
step 2: preparing a resilient mediate layer with pre-set shape and the resilient mediate layer mounted to the prepreg sheets;
step 3: preparing a bladder which is enclosed by the resilient mediate layer;
step 4: putting the assembly of the prepreg sheets, the resilient mediate layer and the bladder in step 3 into a concavity of a mold and heating the mold to solidify the prepreg sheets, and
step 5: removing the solidified prepreg sheets from the concavity of the mold.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the method for making a hollow item;

FIG. 2 is a side view to show a baseball bat of the present invention;

FIG. 3 shows a cross sectional view of baseball bat of the present invention;

FIG. 3A is an end cross sectional view, taken from plane B-B in FIG. 3, to show the composition of the baseball bat;

FIG. 4 is a cross sectional view to show the baseball bat received in a mold;

FIG. 5 shows a cross sectional view of a conventional baseball bat;

FIG. 5A shows an end cross sectional view, taken from plane A-A in FIG. 5, of the conventional baseball bat, and

FIG. 6 shows the conventional baseball bat received in a mold.

### DETAILED DESCRIPTION OF THE PREFERRED EMBODIMENT

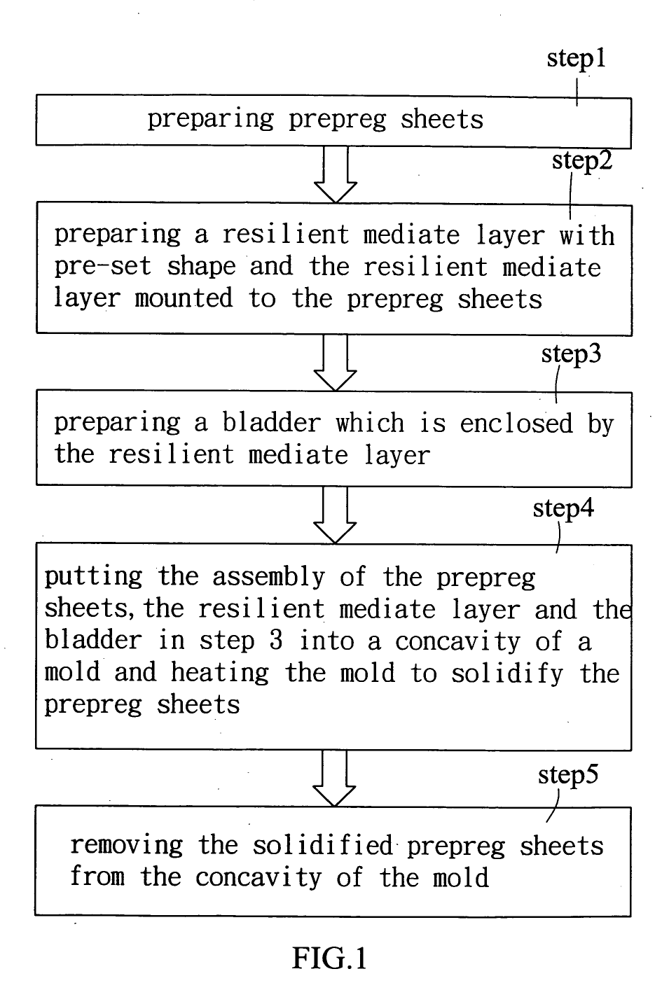

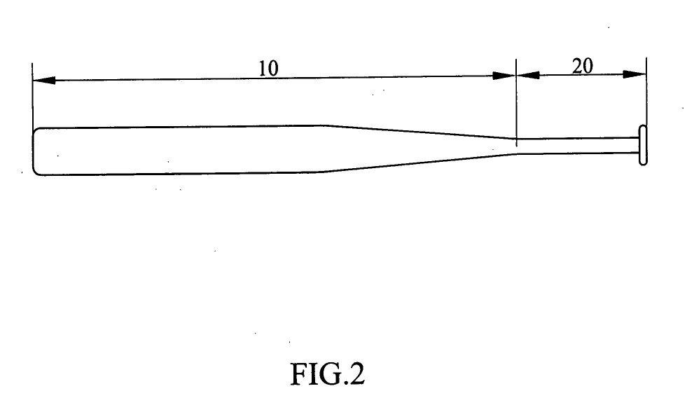

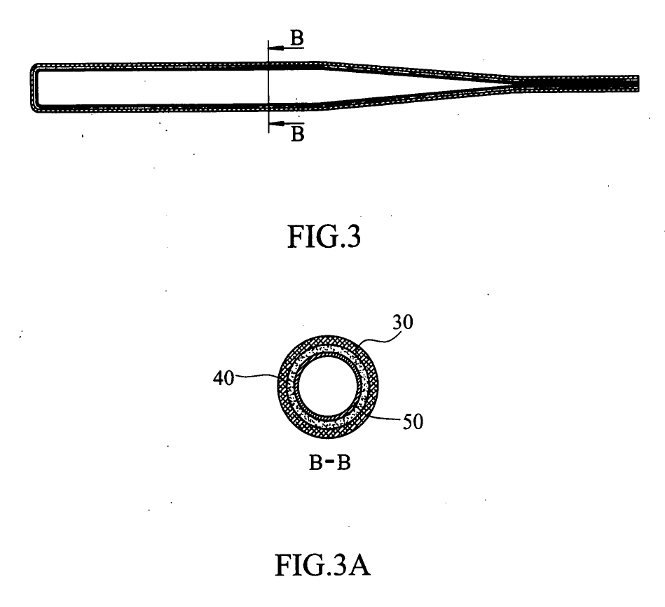

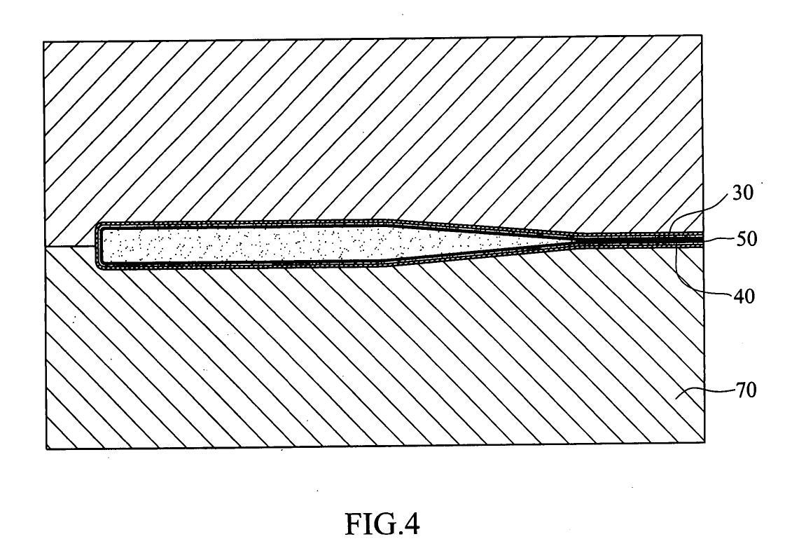

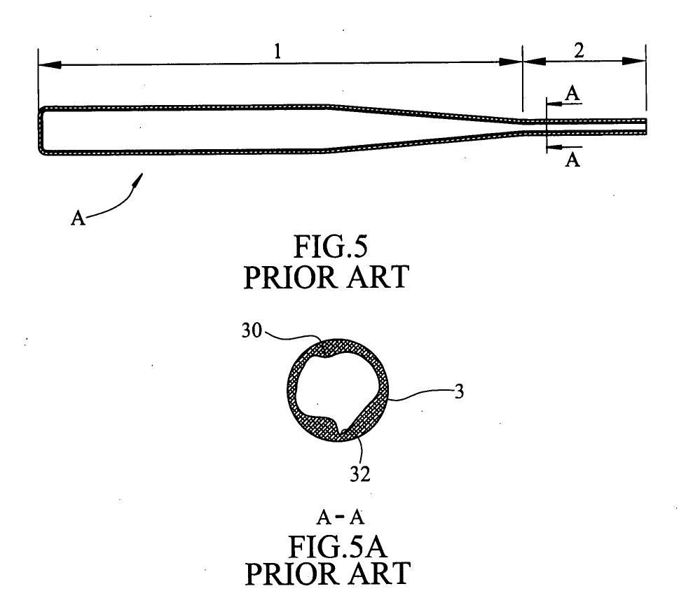

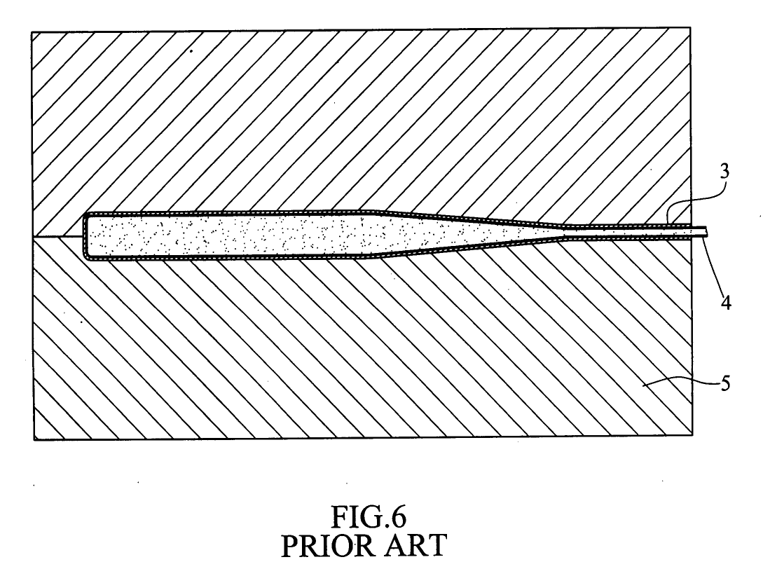

Referring to FIGS. 1 to 3 and 3A, a method for making a hollow item, such as a baseball bat, of the present invention comprises the hollowing steps:
step 1: preparing prepreg sheets 30 which can be carbon or glass fibers;
step 2: preparing a resilient mediate layer 40 with pre-set shape and the resilient mediate layer 40 mounted to the prepreg sheets 30;
The resilient mediate layer 40 is durable to high temperature and reusable.
step 3: preparing a bladder 50 which is enclosed by the resilient mediate layer 40;
step 4: putting the assembly of the prepreg sheets 30, the resilient mediate layer 40 and the bladder 50 in step 3 into a concavity of a mold 70 as shown in FIG. 4 and inflating the bladder 50, heating the mold 70 to solidify the prepreg sheets 30, and
step 5: removing the solidified prepreg sheets 30 from the concavity of the mold 70.

The inflation of the bladder 50 pushes the resilient mediate layer 40 to evenly press the prepreg sheets 30 against the inside of the concavity of the mold 70 so that the item has an outer layer of even thickness. The item includes an open end and a close end, wherein a handle portion can be connected to the open end if needed. In this embodiment, the item is a baseball bat comprising a main part 10 and a handle part 20. It is noted that the thickness of the main part 10 and the handle part 20 is the same.

The prepreg sheets 30 can also be folded to have a large opening such that the item can be a helmet, or even a front fork for bicycles.

While we have shown and described the embodiment in accordance with the present invention, it should be clear to those skilled in the art that further embodiments may be made without departing from the scope of the present invention.

1. A hollow item comprising:
an outer layer made by composite material and having an even thickness.

2. The hollow item as claimed in claim 1 further comprising an open end.

3. The hollow item as claimed in claim 1 further comprising a close end.

4. A method for making a hollow item, comprising the following steps:
step 1: preparing prepreg sheets;
step 2: preparing a resilient mediate layer with pre-set shape and the resilient mediate layer mounted to the prepreg sheets;
step 3: preparing a bladder which is enclosed by the resilient mediate layer;
step 4: putting the assembly of the prepreg sheets, the resilient mediate layer and the bladder in step 3 into a concavity of a mold and heating the mold to solidify the prepreg sheets; and
step 5: removing the solidified prepreg sheets from the concavity of the mold.

5. The method as claimed in claim 4, wherein the resilient mediate layer is durable to high temperature and reusable.

6. The method as claimed in claim 4, wherein the prepreg sheets are made from carbon fibers.

7. The method as claimed in claim 4, wherein the prepreg sheets are made from glass fibers.

8. The method as claimed in claim 4, wherein the prepreg sheets are folded to have an open end.
